(19) United States
(12) Patent Application Publication
(10) Pub. No.: US 2002/0042915 A1
(43) Pub. Date: Apr. 11, 2002

(54) Interactive, off-screen entertainment guide for program selection and control

(76) Inventors: Raymond L. Kubischta, Sammamish, WA (US); Ted M. Tsuchida, Woodinville, WA (US); Paul G. Allen, Mercer Island, WA (US)

Correspondence Address: Dennis M. de Guzman, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/811,373

(22) Filed: Mar. 15, 2001

Related U.S. Application Data
(63) Continuation-in-part of application No. 09/739,576, filed on Dec. 18, 2000.
(60) Provisional application No. 60/238,585, filed on Oct. 6, 2000.

(51) Int. Cl. G06F 3/00; H04N 5/445; G06F 13/00

(52) U.S. Cl. 725/38; 725/61; 725/39

(57) ABSTRACT

A set top box for a television interactive television system receives a television signal and television program schedule information. The set top box transmits the television program schedule information to a remote control using a wireless transmission method. The remote control uses the television program schedule information to generate an interactive electronic programming guide (EPG) on a display device integrated with the remote control. The remote control may also receive the television program schedule information from a network, such as the Internet, and then a user can control the set top box or other device using controls added to the schedule information received from the network.

### CROSS-REFERENCE TO RELATED APPLICATIONS

The present application is a continuation-in-part of U.S. patent application Ser. No. 09/739,576, entitled “INTERACTIVE, OFF-SCREEN ENTERTAINMENT GUIDE,” filed Dec. 18, 2000, which claims priority based on U.S. Provisional Patent Application Serial No. 60/238,585, entitled “INTERACTIVE, OFF-SCREEN ENTERTAINMENT GUIDE,” filed Oct. 6, 2000, all of which are incorporated herein by reference in their entirety.

### TECHNICAL FIELD

This disclosure relates generally to electronic entertainment systems, and more particularly but not exclusively, relates to an interactive, off-screen, electronic programming guide.

### BACKGROUND

In recent years, the television has arguably become the predominant entertainment medium. People with widely varied interests have found the television to be an indispensable source of information and entertainment. Indeed, with the advent of technologies and systems such as cable, satellite, and the Internet, television viewing options have expanded dramatically.

Unfortunately, the great proliferation of available channels can be more than a little confusing, and possibly somewhat daunting, for many viewers. Many viewers do not watch programming they would like to see, simply because they are not aware of it. Others may set their video cassette recorders to record a specified program, only to find that a mistake in the recorder settings, or a change in programming, resulted in the wrong program being recorded.

Known methods of informing users of available programming have proven to be deficient in many areas. Written programming guides, for example, require significant lead time to print and distribute. Consequently, programming changes that occur after printing are not reflected in the written programming guides. Additionally, a viewer must obtain a new programming guide periodically (e.g., weekly) in order to keep the written information current.

Another mechanism for informing users of available programming is an electronic programming guide (EPG). An EPG provides an on-screen listing of all programming and content that television service subscribers have available to them. Unfortunately, existing EPGs also present a number of difficulties.

For example, many such EPGs tend to occupy a substantial portion of the television screen, or even the entire screen, so that a viewer cannot simultaneously view programs and the EPG. A viewer, therefore, is unable to determine what is on other channels without interrupting the viewing of the current channel. This is especially problematic when there is a group of viewers, some of whom are intensely interested in the programming currently on the television, while others wish to see what other programs are available.

Furthermore, EPGs that display programming schedules on the television are only able to display a limited amount of information at once. The low resolution of most standard televisions does not permit the display of more than a few time slots and channels. Furthermore, televisions are usually positioned far enough away from users that smaller text is illegible, especially when the television, itself, is small. Thus, a viewer must manually scroll through several channels or time slots, or wait until the channels or time slots scroll by, to find the particular programming in which he or she is interested.

Therefore, improvements are needed in the presentation of programming information to viewers.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram of a television network according to an embodiment of the invention.

FIG. 2 is a schematic block diagram of an interactive television system according to an embodiment of the invention.

FIG. 3 is a schematic block diagram of a set top box according to an embodiment of the invention.

FIG. 4 is a schematic block diagram of a remote control according to an embodiment of the invention.

FIG. 5 is a flowchart of a method for providing television program schedule information according to an embodiment of the invention.

FIG. 6 is a schematic block diagram of an interactive television system according to another embodiment of the invention.

FIG. 7 is a flowchart of a method for providing television program schedule information and associated control actions according to an embodiment of the invention.

### DETAILED DESCRIPTION OF THE ILLUSTRATED EMBODIMENTS

As an overview, embodiments of a system, apparatus, and method for providing an interactive, off-screen entertainment guide are described herein. In one embodiment, the entertainment guide comprises an electronic program guide (EPG) that can be displayed on a remote device, such as a “web pad,” computer, or other remote control. By displaying the EPG on the remote control, the user can view a more up-to-date programming guide than a hardcopy printed programming guide, and which can be displayed at a better resolution and size for viewing by the user.

Furthermore, displaying the EPG on the remote control allows the television program currently displayed on a television to be undisturbed. That is, the user can review program listings in the EPG displayed on the remote control, without disturbing another user/viewer who is watching a television program on the television. In one embodiment, the EPG displayed on the remote control can be obtained from a network, such as the Internet, in the form of an online EPG. A modification technique according to one embodiment of the invention adds controls to the online EPG obtained from the Internet. In another embodiment, the remote control can display an EPG that is transmitted from a set top box coupled to the television.

In the following description, numerous specific details are provided to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

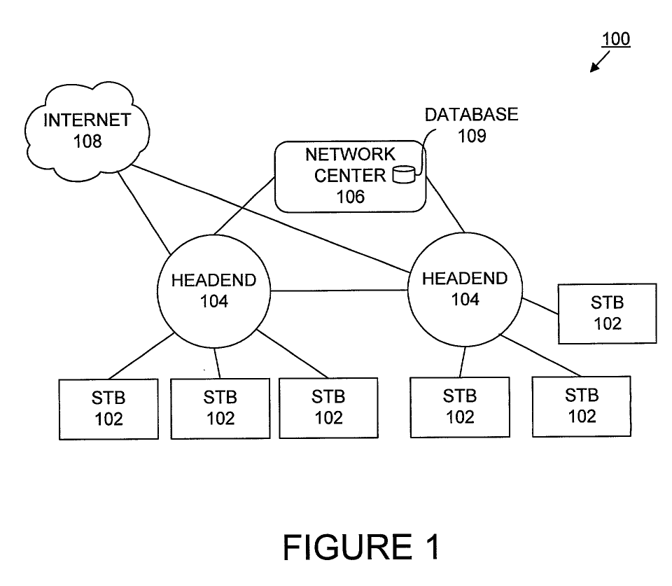

Referring now to FIG. 1, there is shown a television network 100, such as a cable television (CATV) network, according to an embodiment of the invention. In one implementation, the network 100 includes a plurality of set top boxes 102 or other customer premises equipment (CPE) located, for instance, at customer homes.

A set top box 102 (hereinafter “STB 102”) comprises a consumer electronics device that serves as a gateway between a customer's television and a broadband communication network, such as a cable network. As its name implies, an STB 102 is typically located on top of, or in close proximity to, the customer's television. In general, an embodiment of the STB 102 operates in conjunction with data streams encoded using the MPEG standard. STBs 102 are also capable of two-way data streams, allowing consumers to access services such as electronic shopping and video-on-demand.

In one embodiment, an STB 102 receives encoded television signals from the network 100 and decodes the same for display on the television. Additionally, an STB 102 receives commands from a user (via a remote control in one embodiment) and transmits such commands back to the network 100.

In various embodiments, each STB 102 is connected to a headend 104. In the context of a cable network, a headend 104 is a centrally-located facility where CATV transmissions are received from a local CATV satellite downlink and packaged together for transmission to customer homes.

Headends 104 may be coupled directly to one another or through a network center 106. In some cases, headends 104 may be connected via a separate network, one particular example of which is an Internet 108. Of course, the illustrated network topology is provided for example purposes only, and other networks and network configurations may be used within the scope of the invention.

In one embodiment, a database 109 containing schedule information for television programming may be stored within one or more of the headends 104, network centers 106, the Internet 108, or a third party system coupled in one way or another to the headends 104. The database 109 may include, for example, program channels, dates, times, critical reviews, content ratings, VCRPlus® codes, and the like.

In various embodiments, copies of the database 109 are periodically transmitted from the headends 104 or network centers 106 to the STBs 102 for local storage. For example, using a “carousel” technique, a headend 104 may be configured to automatically send updated programming information to the STBs 102. In the carousel technique, a headend 104 sends a certain number of data packets including, for example, television program schedule information, in a particular sequence and then repeats the sequence at regular intervals.

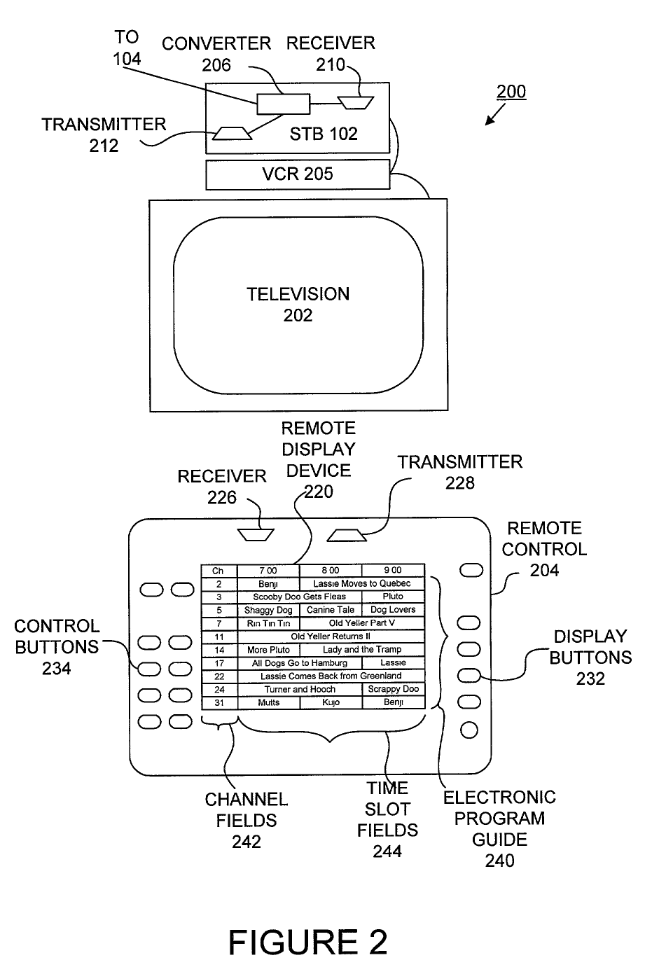

Referring now to FIG. 2, there is shown an interactive television system 200 according to an embodiment of the invention. The interactive television system 200 includes, in one implementation, a television 202, an STB 102, and a remote control 204. In various embodiments, the system 200 may also include a video cassette recorder (VCR) 205 or other recording device.

The television 202 may be configured to display television signals in a variety of formats, including standard analog or digital television formats or high-definition television (HDTV) formats. The television 202 may utilize various technologies to display the television signals, such as standard cathode ray tube (CRT) technology, liquid crystal display (LCD) technology, liquid plasma technology, or projection techniques.

As illustrated, the television 202 can be coupled to an STB 102 in order to receive and display television signals received from the network 100, and more specifically, from a headend 104. In one embodiment, the STB 102 includes a converter 206 for converting digitally encoded (e.g., MPEG) television signals from the network 100 into format directly readable by the television 202. Additionally, as described in greater detail below, the converter 206 may decode television program schedule information or other data received from the network 100.

In the illustrated embodiment, the STB 102 is equipped with a receiver 210, such as an infrared (IR) or radio frequency (RF) receiver 210. In alternative embodiments, the receiver 210 may be configured to receive other frequencies of the electromagnetic spectrum, such as UHF, VHF, microwave, or the like. The receiver 210 can receive control signals from the remote control 204 for operating the STB 102 and the television 202. The receiver 210 may also receive other types of data, such as information requests, e-mail, and the like, for transmission to the network 100.

In one implementation, the STB 102 also includes a transmitter 212, such as an IR or RF transmitter 212. The transmitter 212 is configured, in one embodiment, to broadcast various types of information to the remote control 204, such as television program schedule information, responses to information requests, e-mail, and the like.

As noted, the remote control 204 provides convenient remote operation of the STB 102 and the television 202. Unlike conventional television remote controls, however, an embodiment of the remote control 204 includes a remote display device 220 for displaying an electronic programming guide (EPG), as described in greater detail below.

In an embodiment, the remote control 204 is of a size and weight convenient to be conveniently held in a viewer's hands or lap. In one embodiment, the remote control 204 may be approximately 8 inches wide and 11 inches tall, or about the size of a conventional paper notebook. In an embodiment, the remote control 204 is comparatively lightweight, for example, under three pounds.

In the illustrated embodiment, the remote control 204 includes a receiver 226, such as an RF or IR receiver 226, for receiving signals sent by the transmitter 212 of the STB 102. As mentioned above, these signals may include the television program schedule information retrieved by the STB 102 from the network 100. Additionally, the remote control 204 may include a transmitter 228, such as an RF, IR, or other transmitter 228, that transmits control signals and other data to the receiver 210 of the STB 102, as well as to the television 202 (e.g., to adjust the television's 202 volume).

In one embodiment, the transmitters 212, 228 modulate signals with a carrier frequency to enable transmission of information between the STB 102 and the remote control 204. For example, the transmitters 212, 228 may operate according to the IEEE 802.11a or 802.11b Wireless Networking standards. Alternatively, the transmitters 212, 228 may utilize DECT or “Bluetooth” or other standard or proprietary protocols. In an embodiment, the transmitters 212, 228 may be configured to transmit other frequencies of the electromagnetic spectrum, such as UHF, VHF, microwave, or the like.

To perform modulation and transmission, the transmitters 212, 228 may include various additional components not specifically illustrated. For example, the transmitters 212, 228 may include source encoders to reduce the amount of bandwidth required, channel encoders to modulate the transmitted information with a carrier wave, and transmission antennas to broadcast the information. The antennas may be substantially two-dimensional structures formed as part of a printed circuit board within the remote control 204 and STB 102 in one embodiment. Such integrated antennas are advantageously compact and efficient to manufacture. The transmitters 212, 228 may further include amplifiers to increase the transmission signal strength to an appropriate power level.

The receivers 210, 226 may further include components not specifically illustrated but well known in the art. For example, the receivers 210, 226 may include antennas for receiving the transmission, amplifiers for increasing the strength of the received signal, and decoders for separating and demodulating information from the carrier signal. These antennas may also be integrated into printed circuit boards of the remote control 204 and STB 102.

As previously noted, the remote control 204 includes, in one embodiment, a remote display device 220, which is compact yet large enough to be easily readable in one embodiment. For example, a screen may have a 10.4-inch diagonal measure with a standard 4:3 aspect ratio. The remote display device 220 may be embodied as a monochrome or color liquid crystal display (LCD) screen. To implement a color remote display device 220, a number of technologies may be utilized, including passive matrix, dual scan, HPA, TFT, or liquid plasma LCD technology. The remote display device 220 may advantageously utilize TFT LCD technology to achieve high brightness, clear motion, and a comparatively large viewing angle.

Display buttons 232 may be provided and conveniently located on the remote control 204 to control various aspects of the remote display device 220. The display buttons 232 may include buttons to vertically or horizontally scroll material on the remote display device 220, to adjust the brightness, contrast, and coloration of the remote display device 220, or to place the remote display device 220 in an “on,” “off,” or “standby” setting. As used herein, the term “button” contemplates other types of controls, such as switches and the like. In addition, multiple buttons or controls may be provided for performing a particular function. Thus, the term “button” means one or more controls for performing the stated function.

Additionally, control buttons 234 may also be provided on the remote control 204 to control the operation of the STB 102 and/or the television 202. The control buttons 234 may include channel selection, volume adjustment, power on/off, brightness, contrast, and coloration, and the like. The control buttons 234 may also be configured to control other devices, such as the VCR 205, a digital video disc (DVD) player, a compact disc (CD) player, a tuner, an amplifier, or a receiver.

In one embodiment, the remote display device 220 is adapted to present an interactive EPG 240, which is generated from the television program schedule information received from the STB 102. One embodiment of the EPG 240 is depicted in FIG. 2. Channel fields 242 may be vertically arranged as rows, in ascending order, along the left edge of the remote display device 220. Each of the channel fields 242 may correspond to a single channel available from the network 100. Time slot fields 244 may be provided in columns to indicate which programs are on a given channel at a given time. In alternative embodiments, channel fields may be arranged as columns and time slot fields may be arranged as rows. A system for displaying television program schedule information is disclosed in U.S. Pat. No. 5,532,754, entitled “BACKGROUND TELEVISION SCHEDULE SYSTEM,” which is incorporated herein by reference in its entirety.

Several time increments may be simultaneously depicted, as shown in FIG. 2. A viewer may thus obtain an overview of television program schedule information corresponding to the present time and for several hours thereafter without having to scroll the EPG 240 to view additional time increments. Nevertheless, a user may scroll the EPG 240 on the remote display device 220 vertically to see programming for additional channels, or horizontally, to see additional time slots.

Optionally, the remote display device 220 may provide touch sensitivity, which may be implemented using technologies well known or available to those skilled in the art. Thus, a user may press against a particular portion of the screen with a finger or other object, such as a stylus, to select “virtual” buttons or controls displayed upon the remote display device 220. If the remote display device 220 is configured as a touch screen, many, or possibly even all, of the buttons 232, 234 may not be needed.

In one embodiment, a viewer selects a television program to watch by touching a corresponding indication of the television program on the EPG 240. In one embodiment, a user may touch any location within a row to switch to the corresponding channel. Alternatively, the user may select a channel by means of the control buttons 234.

Likewise, the remote control 204 may be configured to program the VCR 205 or other recording device in response to the user touching an indication of the desired program in the EPG 240, rather than requiring the user to manually enter the channel, start time, stop time, etc. In one implementation, the remote control 204 transmits an appropriate VCRPlus® code from the database 109 to the VCR 205 in response to a user selection of a program from the EPG 240. A viewer may thus rapidly program a VCR 205 with a much lower probability of error.

Optionally, a user may activate an on-screen keyboard, by which a user may input letters, numbers, or other symbols. Such a configuration is particularly advantageous if a user wishes to use the remote control 204 to send e-mail or for other text-based applications.

The remote control 204 need not be limited to reception of television program schedule information, but may also be used for more varied, higher-bandwidth applications. For example, the STB 102 may be configured to send to the remote control 204 background information for television programs, such as pictures of actors and actresses, video previews, and audio/video interviews with people associated with the program. In one embodiment, a secondary television signal may be sent to the remote control 204 such that one viewer can watch a program on the remote display device 220 while another viewer watches a different program on the television 202. Similarly, a viewer may wish to convey higher-bandwidth information from the remote control 204 to other viewers connected to the network 100, such as a video or audio stream, captured by an integrated camera/microphone within the remote control 204.

In such an embodiment, the transmitters 212, 228 and receivers 210, 226 may be configured for high-bandwidth transmission and reception, which may use, for example, frequency division multiplexing (FDM) or other techniques. Transmission of video and audio between the STB 102 and the remote control 204 may operate according to various standard protocols, such as MPEG and video over IP.

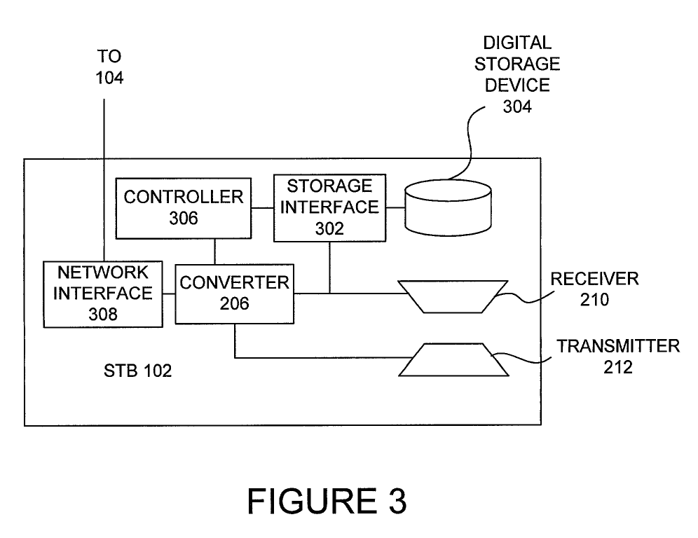

Referring to FIG. 3, there is shown an expanded block diagram of one possible embodiment of an STB 102. As shown in FIG. 3, the STB 102 may include a number of additional components beyond those depicted in FIG. 2. For example, the STB 102 may include a storage interface 302, which provides an interface with a digital storage device 304, such as a hard disk drive or other memory device. In one embodiment, the storage interface 302 receives video/audio information, such as program previews and the like, from the converter 206 and delivers the same to the digital storage device 304 for storage thereof. When a user desires to review the stored video/audio information, the information may be transmitted through the transmitter 212 of the STB 102 to the receiver 226 of the remote control 204 for display on the remote display device 220.

In one embodiment, the STB 102 further includes a controller 306 that is in communication with the storage interface 302 and the converter 206. The controller 306 may be embodied as a microcontroller, microprocessor, digital signal processor (DSP) or other device known in the art. The controller 306 may manage the operation of the STB 102, including, for example, reception of the television program schedule information from the network 100, transmission of the television program schedule information to the remote control 204, the storage and retrieval of supplemental video/audio information, etc. As noted above, the controller 306 may perform these and other operations based upon control signals generated by the remote control 204 and transmitted to the receiver 210.

In one embodiment, the STB 102 includes a separate network interface 308 for providing access to the network 100. The type of network interface 308 can vary depending on the underlying network 100. In a cable network, for instance, the network interface 308 may comprise a cable modem or the like. In alternative embodiments, the functionality of the network interface 308 may be provided by the converter 206.

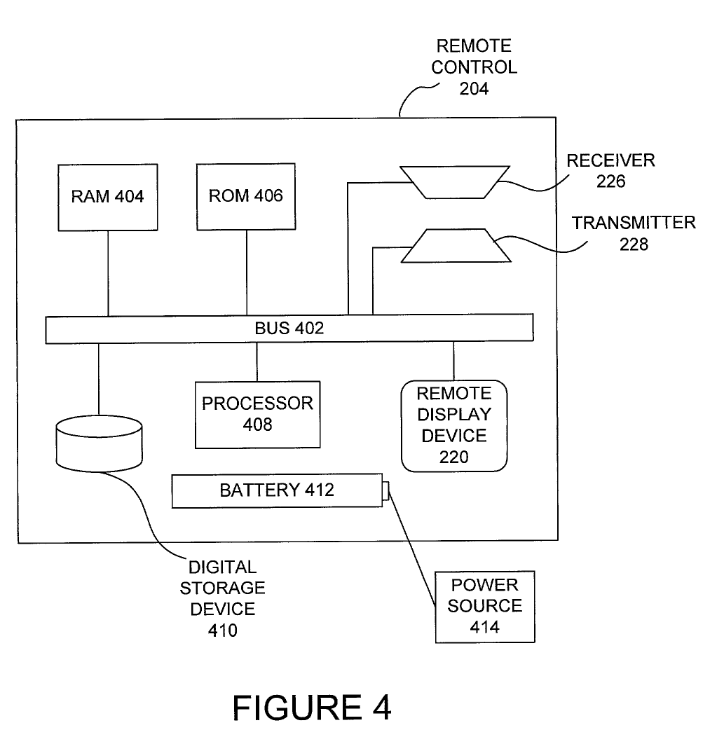

FIG. 4 provides a more detailed, schematic representation of the remote control 204, including the receiver 226, transmitter 228, and the remote display device 220. As shown in FIG. 4, addition components may be included. For example, the remote control 204 may include a bus 402 to enable data transfers between the various components of the remote control 204.

The bus 402 may be electrically connected to random access memory, or RAM 404, configured to store data for temporary use, such as current television program schedule information. Similarly, a read-only memory (ROM) 406, may be provided to store more permanent data, such as fixed code and configuration data. In one embodiment, the ROM 406 may be configured to store an operating system for the remote control 204.

The remote control 204 may also include a processor 408 for performing high-level processing functions, such as preparing and formatting the EPG 240 for display on the remote display device 220. The processor 408 may also sense a user's operation of the control buttons 234 or the “virtual” buttons displayed on the remote display device 220, and generate appropriate command signals for transmission to the STB 102 and/or television 202. The processor 408 may be embodied as a microprocessor, microcontroller, digital signal processor (DSP), field programmable gate array (FPGA), application-specific integrated circuit (ASIC), or other suitable device.

Additionally, the remote control 204 may include a machine-readable storage medium, such as a digital storage device 410 for storage of schedule information, video/audio information, and the like. Like the digital storage device 304 of the STB 102, the digital storage device 410 may comprise a hard disk drive or other memory storage device, such as “flash” memory.

The digital storage device 410 may also store an operating system for the remote control 204, such as Windows®, Mac O/S®, or UNIX®. In one embodiment, the operating system comprises a comparatively compact and customizable platform such as Windows CE® or Linux®. The operating system may be configured to use the Wireless Application Protocol (WAP) to access information remotely from the STB 102 and/or the network 100.

Additionally, the remote control 204 may have a battery 412 to provide power for the remote control 204. In one embodiment, the battery 412 is a rechargeable battery having a comparatively long life, such as 4 or more hours. The battery 412 may utilize various advanced storage technologies, such as Lithium Ion technology, to provide enhanced power output, durability, and recharge times.

The battery 412 may be recharged through the use of a power source 414. The power source 414 may be embodied in number of different configurations. For example, the power source 414 may comprise a power cord designed to be plugged into a conventional, household power outlet. Alternatively, the power source 414 may be part of a charging unit (not shown), in which the remote control 204 may be stored and recharged. The power source 414 may then comprise contacts configured to mate with corresponding contacts of the charging unit. Alternatively, a magnetic coupling, such as a transformer, may be used to energize the remote control 204 without the use of exposed electrical contacts on the remote control 204 or the charging unit. The charging unit may hold the remote control 204 at an orientation convenient for viewing so that the remote control 204 can be used while in the charging unit.

Those skilled in the art will recognize that the various components of the remote control 204 may be embodied in a number of different configurations for ergonomics and ease-of-use.

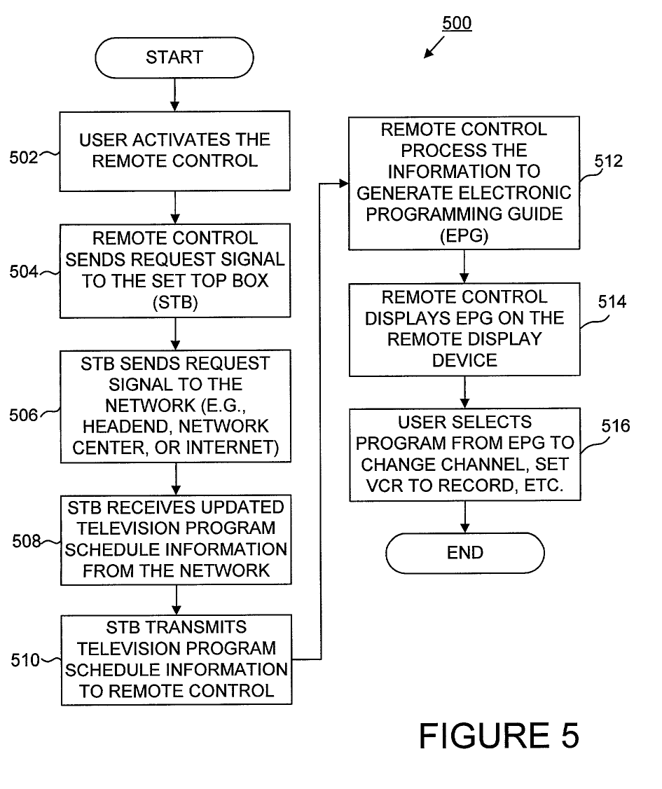

Referring now to FIG. 5, there is shown a flowchart of one possible embodiment of a method 500 for obtaining and viewing television program schedule information in the form of the EPG 240. The method 500 begins, in one embodiment, when a user activates 502 the remote control 204. As described above, the remote control 204 may be activated by pressing a designated button 232, 234.

In one embodiment, the remote control 204 transmits 504 a request signal to the STB 102 to request updated television program schedule information. In an alternative embodiment, the STB 102 may transmit updated information to the remote control 204 at regular intervals, obviating the need to make a specific request to the STB 102. In certain embodiments, the STB 102 may be in a “standby” mode until the request signal is received, in which case the STB 102 is placed in a “ready” or fully-functional mode in response to the request signal.

After receiving the request signal, the STB 102 may send 506 a request signal to the network 100 (e.g., headend 104, network center 106, or the Internet 108) to request updated television program schedule information from the database 109 or from some other location. In an alternative embodiment, as noted above, the STB 102 may receive information updates from the network 100 at regular intervals, obviating the need to make a specific request.

In one embodiment, the STB 102 receives 508 the updated television program schedule information from the network 100, which is then transmitted 510 to the remote control 204 using a wireless method, as described above. The remote control 204 receives and processes 512 the television program schedule information in the processor 408 in order to generate the interactive EPG 240. The remote control 204 then displays 514 the EPG 240 on the remote display device 220.

In one embodiment, a viewer may scroll the EPG 240 on the remote display device 220 to view additional channels or time slots. In various embodiments, the user may select filter settings for programming a user wishes to specifically include or exclude from the EPG 240, and the like.

In one implementation, the user may select 516 a program from the EPG 240 in order to change the channel displayed by the television 202, to program a VCR 205, or the like. In an embodiment in which the remote display device 220 is a touch screen, a user may simply touch an indication of a television program on the EPG 240 in order to display the program or schedule the recording of the program.

The various embodiments of the invention shown in FIGS. 2-5 are useful in situations when the user wishes to view an EPG from a shorter distance (e.g., in close physical proximity to the user), rather than having to gaze across a room to view the EPG on the display screen of the television 202. By being able to view the EPG 240 on the remote display device 220 of the remote control unit 204, the user can view the television programming information at a better resolution, at a better viewing size or viewing range, and with more information displayed for viewing.

One embodiment of the invention according to FIGS. 2-5 allows the user to view the EPG 240 on the remote display device 220, while a television program is concurrently being shown on the display screen of the television 202. This feature allows the user to simultaneously view the EPG 240 without disturbing the viewing of the television program on the television 202. That is, the user or other viewers in the room need not have their viewing of the television program interrupted by having the channel changed to an EPG channel or by having an EPG superimposed over the television program. In an embodiment, this feature can be implemented by an STB 102 that can separately send EPG information to the remote control 204 (via the transmitter 212), while concurrently sending a television program signal to the television 202. The various components of the STB 102 shown in FIG. 3 can perform the appropriate signal reception, signal processing and tuning, separate signal transmission, information storage, and the like, to allow EPG information to be provided to the remote control device 204 separately from a television signal provided to the television 202 (or to the VCR 205).

Alternatively or in addition to the above-described embodiments shown in FIGS. 2-5 that can provide the EPG 240 to the remote control 204 simultaneously with providing a television program to the television 202, another embodiment of the invention can also provide this feature using a different technique. In this embodiment, an EPG can be obtained from a web site on the Internet 108 by the remote control 204 (or via some other device), transcoded, and then used for television program selection or other control of the STB 102, television 202, VCR 205, or other unit.

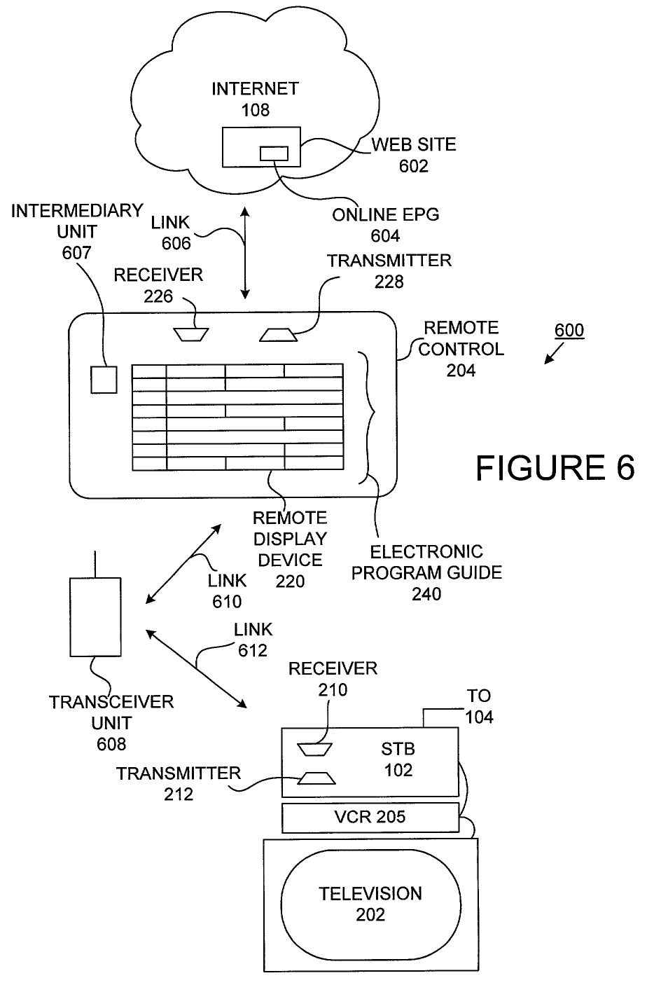

An embodiment of an interactive television system that can use an EPG obtained from the Internet 108 (or other communication network) is shown generally at 600 in FIG. 6. An Internet web site 602, residing in a web server, can provide an online EPG 604 having television program schedule information. The online EPG 604 can be made available on and accessible from the web site 602 via conventional devices that have web browsers, such as personal computers (PCs), laptops, handheld wireless devices, or other communication devices. In one embodiment, the remote control 204 can be used to access the online EPG 604 and other information on the web site 602.

For simplicity of explanation, an embodiment will be described herein as using the remote control 204 to access the online EPG 604 from the web site 602. It is to be appreciated that in other embodiments, a PC, laptop, wireless device, or other communication device can be used to obtain the online EPG 604.

The online EPG 604 can be any of the currently available EPGs offered by commercial web sites, such as Infospace.com. With these EPGs, users can enter a local zip code or their address to obtain updated television program information for their area. In one embodiment, the online EPG 604 can be provided as a hypertext markup language (HTML) file, using a protocol such as hypertext transfer protocol (HTTP). For the sake of simplicity of explanation, the online EPG 604 will be described hereinafter in the context of HTTP and HTML. It is to be appreciated that in other embodiments of the invention, the online EPG 604 (and associated television program schedule information) can be provided using other formats and/or protocols, such as file transfer protocol (FTP), transmission control protocol/Internet protocol (TCP/IP), user datagram protocol (UDP), extensible markup language (XML) format, and the like.

The web site 602 can be accessed by the remote control 204 via a link 606. The link 606 can be a wireless link, or it can be a conventional hardwire link such as twisted pair, digital subscriber line (XDSL), and the like. The link 606 can also comprise part of the network interface 308 in one embodiment. Via the link 606, HTTP requests and HTTP responses can be exchanged between the web server of the web site 602 and a web browser installed in the remote control 204. In accordance with an embodiment of the invention, a service, proxy, server, or other intermediary unit 607 stored in or integrated with the remote control 204, can be located as an interface between the web server and the web browser in order to perform transcoding and other operations, as will be described in further detail below. In other embodiments, the intermediary unit 607 can be stored in the STB 102, headend 104, or other suitable location such that the intermediary unit 607 is located in the communication path between the web site 602 and a device that ultimately displays a transcoded version of the online EPG 604.

If the user uses the remote control 204 to request the online EPG 604 from the web site 602, then the online EPG 604 is displayed/rendered on the remote display device 220 as the EPG 240, after being processed by the intermediary unit 607. That is, the intermediary unit 607 in the remote control 204 performs various operations on the retrieved HTML file having the online EPG 604 data, such as transcoding to provide the EPG 604 with control functions. These control functions are added because without them, the online EPG 604 is a basic HTML file for viewing only. With transcoding, the HTML file is modified by the intermediary unit 607 such that control functions are added to allow the user to use the remote control's 204 buttons 232 or 234 to select channels from the displayed EPG 240 that was derived from the original online EPG 604, or to perform manipulation of the displayed EPG information (such as sorting, magnifying, organizing, and the like). Thus, the user can view the displayed EPG 240 on the remote control 204 without interrupting the television program that is being concurrently displayed on the television 202. If the user uses the buttons 232 or 234 to select a channel displayed by the EPG 240, then the transcoded file having control functionality can interpret this activity and identify the selected channel, and trigger transmission of a signal (to be received by the STB 102) to tune to this channel.

The signal transmitted by the remote control 204 can be a signal sent by the transmitter 228 to the STB 102 to tune to a selected channel. The transmitted signal can also be for control operations, such as volume adjustment, picture/color adjustment, fine tuning, scheduling recording for the VCR 205, and the like. In one embodiment, the signal can be sent directly from the transmitter 228 to the receiver 210 of the STB in a wireless manner. In another embodiment, the signal can be sent via a hardwire link. The transmitter 228 can also send the signal to the VCR 205, to the television 202, or to another device alternatively or in addition to sending to the STB 102.

In accordance with one embodiment of the invention, the remote control 204 can first send the signal to a transceiver unit 608, instead of sending it directly to the STB 102. The signal may be send via a hardwire or wireless link 610, as an IR or RF signal for instance. The transceiver unit 608, in one embodiment, can comprise a commercially available “IR Blaster.” As is known, an IR Blaster can receive a signal from one unit and then transmit the signal to one or more other units, thereby acting as an intermediate amplifier and directional (or non-directional) antenna, particularly if the unit that originally transmitted the signal does not have sufficient range to transmit directly to the receiving unit(s). In one embodiment, the transceiver unit 608 can be a “learning unit” that can be set to communicate/interface with a variety of different devices, such as the STB 102, the VCR 205, and the television 202.

The transceiver unit 608 can transmit to these devices via a hardwire or wireless link 612, which may be an IR or RF link according to various embodiments. In particular, the link 612 can be a wireless link to the receiver 210 of the STB 102, or to receivers of other devices. It is to be appreciated that the links 610 and 612 can be two-way links such that data can be eventually received by the receiver 226 of the remote control 204. Also, suitable devices such as IR-to-RF or RF-to-IR components can be present in the various units to allow transmission and reception of compatible signals.

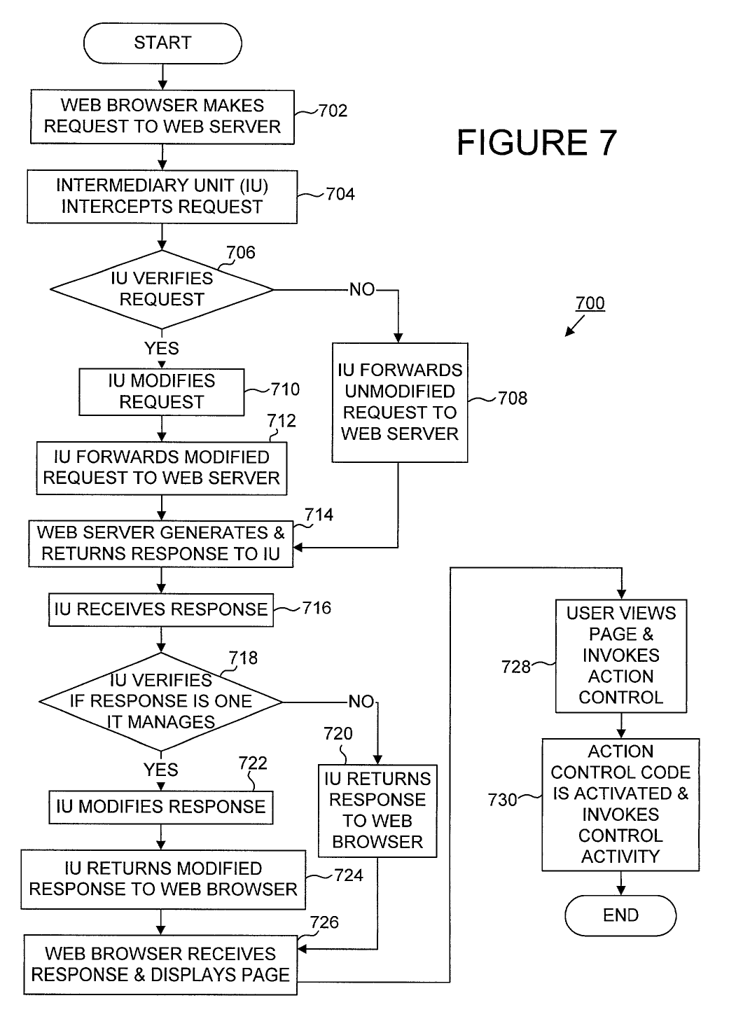

Shown next at 700 in FIG. 7 is a flowchart of an embodiment of a method for providing television program schedule information and associated control actions. At least some of portions of the method 700 can be embodied in software of the intermediary unit 607 or other machine-readable instructions stored on a machine-readable medium. For instance, software of the intermediary unit 607 can be stored in the RAM 404 and/or ROM 406 of the remote control 204, and executed by the processor 408. Furthermore, a web browser installed in the remote control 204 can perform some portions of the method 700.

Beginning at 702, the web browser in the remote control 204 makes a request to the web server of the web site 602. In one embodiment, such a request may be an HTTP request that is made if the user wishes to access and view the online EPG 604 from the remote control 204. At 704, the intermediary unit 607 intercepts the request sent by the web browser, and verifies at 706 whether the request is one that it manages. That is, if the request is a non-EPG request, then the intermediary unit 607 forwards the request (unmodified) to the web server at 708.

If at 706, however, the request is verified to be a request for the online EPG 604, then the request is one that the intermediary unit 607 manages, and the request is modified by the intermediary unit 607 at 710. Modification of the request at 710 can include several possible types of modifications. In one embodiment, the intermediary unit 607 modifies the request data to specify a service location (such as a zip code), time, date, alternate web site address, and the like, as examples. By performing this modification, the user need not explicitly enter this information when making the request. Instead, if such information has been pre-programmed or pre-stored into the remote control 204, then the user can simply press one of the buttons 232,234 to send the request for the online EPG 604, and the intermediary unit 607 modifies the request to include/insert this information in the request.

At 712, the intermediary unit 607 forwards the modified request for the online EPG 604 to the web server where the web site 602 is located, via the link 606. The web server generates and returns a response to the intermediary unit 607 at 714. In one embodiment, this response is in the form of one or more HTML files of the online EPG 604 having television program schedule information.

The response is received by the intermediary unit 607 at 716. At 718, the intermediary unit 607 verifies if the response is one that it manages. If it is not a response that it manages, such as if the response is of a non-EPG nature, then the response is returned to the web browser at 720. After 720, the web browser receives the response and displays the page at 726, and thereafter, the process can end.

If at 718, however, the intermediary unit 607 verifies that the response is one that it manages (e.g., verifies that the response is an HTML page of the online EPG 604), then the intermediary unit 607 modifies the response at 722. The modification of the response at 722 can include a number of various activities. In one embodiment, the modification can involve transcoding or other transformation of the response from one form to another. A type of suitable transcoding technique that can be used by one embodiment of the invention can be based on the Web Intermediaries (WBI) framework of IBM Corporation. Using this framework or other transcoding technique, the intermediary unit 607 can modify the response at 722 to remove advertisements and to reformat content, colors, text fonts, or other elements. The modification at 722 can also include parental control activities to filter out certain channels from the returned online EPG 604. Channels may also be grouped together, organized into “favorites,” or displayed using a different layout. These various modifications are intended herein to be illustrative and non-exhausted.

In an embodiment of the invention, the modification by the intermediary unit 607 at 722 includes transcoding of the response to add controls. For instance, JavaScript™ or other suitable code for action control can be added to the HTML file or page to allow changing of channels by the STB 102, scheduling recording by the VCR 205, or other action to control television viewing. By adding this action control code (e.g., JavaScript™—coded function) to the response, the user can select or control television program via use of the online EPG 604 obtained from the web site 602.

Next at 724, after the response has been appropriately modified at 722, the intermediary unit returns the modified response to the web browser. At 726, the web browser receives the response and displays/renders the corresponding page. In an embodiment, the displayed page can be the modified HTML page that is displayed as the EPG 240 on the remote display device 220.

The user can view the displayed EPG 240 at 728. This viewing can include activities such as scrolling, enlarging, grouping favorites, and the like. If the user invokes an action control at 728, such as using one of the buttons 234 to select a channel from the EPG 240 that the user wishes to tune to, then the corresponding action control code is activated at 730. Activation or execution of the action control code invokes a corresponding control activity. In one embodiment, this control activity includes generation of a signal that is transmitted from the transmitter 228 of the remote control 204 to the transceiver unit 608 and/or directly to the STB 102, VCR 205, or television 202 in a hardwired or wireless manner previously described above. Upon receipt of this signal from the transceiver unit 608, for example, the STB 102 can tune to the selected channel.

In view of the foregoing, an embodiment of the present invention offers numerous benefits not available in conventional approaches. By integrating the remote display device 220 with the remote control 204, a user may conveniently check television program listings, without interfering with television viewing by other users. The database 109 and/or the online EPG 604 having television program schedule information may be kept more current than conventional, printed entertainment guides. Indeed, in one embodiment, the database 109 and/or online EPG 604 may be maintained by the television and cable networks, providing the most accurate, up-to-date information available.

Moreover, the present invention provides the EPG 240 on the remote control 204, allowing a user to conveniently select one or more television programs to display on the television 202 or schedule for recording. In one embodiment, a touch screen interface is provided, whereby a user may easily select a program by touching an indication of the program in the EPG 240.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

For instance, while various embodiments have been described above as using the remote control 204 to directly obtain the online EPG 604 from the web site 602, it is to be appreciated that other devices can obtain the online EPG 604 instead of, or in addition to, the remote control 204. A PC connected to the Internet 108 can be used by the user to obtain the online EPG 604, modifying it as described according to the method 700 of FIG. 7, and then invoke action controls of the modified online EPG 604 to control television viewing from the PC.

Furthermore, multiple remote controls 204 or other devices (such as PCs) can be used in parallel to allow multiple users in a room to independently view the modified online EPG 604 and correspondingly control their television viewing. Multiple remote controls 204 or other devices (such as PCs) may also be connected in series (via the transceiver unit 608 or via another link), to provide increased range. Thus, if a PC's Internet connection is in one room, the transceiver unit 608 may be used to relay the modified online EPG 604 (or other signals) from the PC to the remote control 204, which may be in another room.

As yet another modification, the intermediary unit 607 may be integrated with the STB 102 alternatively or in addition to being integrated with the remote control 204. A possible application of this modification is if the STB 102 is being used as the device to access the Internet 108. The integration of the intermediary unit 607 in the STB 102 allows the intermediary unit 607 to perform the transcoding described above prior to the transmission of the EPG data from the STB 102 to the remote control 204 for display on the remote display device 220.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

### APPENDIX A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Todd M. Becker, Reg. No. 43,487; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Thomas M. Coester, Reg. No. 39,637; Donna Jo Coningsby, Reg. No. 41,684; Florin Corie, Reg. No. 46,244; Mimi Diemmy Dao, Reg. No. 45,628; Dennis M. deGuzman, Reg. No. 41,702; Stephen M. De Klerk, Reg. No. 46,503; Michael Anthony DeSanctis, Reg. No. 39,957; Daniel M. De Vos, Reg. No. 37,813; Justin M. Dillon, Reg. No. 42,486; Sanjeet Dutta, Reg. No. 46,145; Matthew C. Fagan, Reg. No. 37,542; Tarek N. Fahmi, Reg. No. 41,402; Thomas S. Ferrill, Reg. No. 42,532; George Fountain, Reg. No. 37,374; James Y. Go, Reg. No. 40,621; James A. Henry, Reg. No. 41,064; Libby N. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George Brian Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Julio Loza, Reg. No. P47,758; Joseph Lutz, Reg. No. 43,765; Lawrence E. Lycke, Reg. No. 38,540; Michael J. Mallie, Reg. No. 36,591; Andre L. Marais, Reg. No. P048,095; Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Robert B. O'Rourke, Reg. No. 46,972; Daniel E. Ovanezian, Reg. No. 41,236; Kenneth B. Paley, Reg. No. 38,989; Gregg A. Peacock, Reg. No. 45,001; Marina Portnova, Reg. No. 45,750; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Maria McCormack Sobrino, Reg. No. 31,639; Stanley W. Sokoloff, Reg. No. 25,128; Judith A. Szepesi, Reg. No. 39,393; Edwin H. Taylor, Reg. No. 25,129; Lance A. Termes, Reg. No. 43,184; John F. Travis, Reg. No. 43,203; Joseph A. Twarowski, Reg. No. 42,191; Mark C. Van Ness, Reg. No. 39,865; Tom Van Zandt, Reg. No. 43,219; Brent E. Vecchia, Reg. No. P48,011; Lester J. Vincent, Reg. No. 31,460; Archana B. Vittal, Reg. No. 45,182; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Firasat Ali, Reg. No. 45,715; and Raul Martinez, Reg. No. 46,904, my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and James K. Okamoto, Reg. No. 40,110; Steven D. Young, Reg. No. 43,300; and James R. Thein, Reg. No. 31,710, my patent attorney with full power of substitution and revocation, to prosecute this application and to transact all business in the Patent and Trademark Office connected herewith.

### APPENDIX B

### Title 37, Code of Federal Regulations, Section 1.56

### Duty to Disclose Information Material to Patentability

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclose information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclose all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made of record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

(e) In any continuation-in-part application, the duty under this section includes the duty to disclose to the Office all information known to the person to be material to patentability, as defined in paragraph (b) of this section, which became available between the filing date of the prior application and the national or PCT international filing date of the continuation-in-part application.

What is claimed is:

1. An entertainment device, comprising:
a remote control for an interactive television system;
a wireless receiver integrated with the remote control to receive television program schedule information from the interactive television system; and
a display device integrated with the remote control to display the television program schedule information.

2. The device of claim 1, further comprising a processor integrated with the remote control to generate an electronic programming guide from the television program schedule information to display on the display device.

3. The device of claim 2 wherein the electronic programming guide comprises at least one indication of a television program, the device further comprising a wireless transmitter integrated with the remote to transmit a control signal to the interactive television system in response to a user selection of a television program from the electronic programming guide.

4. The device of claim 3 wherein the control signal is configured to cause a television to display the selected television program.

5. The device of claim 1 wherein the interactive television system includes a set top box, the wireless receiver integrated with the remote control capable to receive the television program information from the set top box.

6. The device of claim 1 wherein the remote control is coupleable to a network, the remote control capable to receive television program schedule information from the network.

7. The device of claim 6 wherein the network comprises an Internet, and wherein the television program schedule information is received by the remote control from a web site on the Internet.

8. The device of claim 6 wherein the display device comprises part of a computer.

9. The device of claim 6 wherein the remote control further comprises an intermediary unit to transcode the television program schedule information received from the network from one format to another format.

10. The device of claim 9 wherein the intermediary unit is capable to add action control code to the television program schedule information, as part of the transcoding from one format to another format.

11. The device of claim 10 wherein the remote control includes control buttons, and wherein activation of one of the control buttons activates the action control code added to the television program schedule information.

12. The device of claim 11 wherein activation of the action control code triggers generation of a corresponding signal for a control activity, the remote control further including a transmitter integrated therewith to transmit the generated signal.

13. The device of claim 10 wherein the television program schedule information comprises part of a hypertext markup language (HTML) page, and wherein the action control code comprises JavaScript.

14. The device of claim 9 wherein the intermediary unit is further capable to remove or add information to the television program schedule information received from the network, as part of the transcoding from one format to another format.

15. The device of claim 9 wherein the intermediary unit is capable to reformat one of a content, color, text font, layout, organization, or parental control feature of the television program schedule information received from the network, as part of the transcoding from one format to another format.

16. The device of claim 6, further comprising a transceiver unit communicatively coupleable to the remote control, the remote control including a transmitter integrated therewith to send signals to the transceiver unit, the signals corresponding to action controls invoked on the television program schedule information received from the network.

17. The device of claim 9, further comprising a browser in the remote control to display the television program schedule, which is received from the network and transcoded by the intermediary unit, as an electronic program guide on the display device.

18. An apparatus, comprising:
a remote control for an interactive television system, the remote control including a browser;
an intermediary unit integrated with the remote control to receive information sent between the browser and a network; and
a display device integrated with the remote control to display television program schedule information obtainable by the intermediary unit from the network, the intermediary unit capable to modify the obtained television program schedule information to add controls corresponding thereto prior to display of the modified television program schedule information on the display device by the browser.

19. The apparatus of claim 18 wherein the remote control comprises a computer.

20. The apparatus of claim 18 wherein the remote control comprises a wireless device.

21. The apparatus of claim 18, further comprising control buttons integrated with the remote control, wherein modification of the obtained television program schedule information to add controls corresponding thereto includes transcoding to add action control code responsive to the control buttons, wherein activation of one of the control buttons triggers activation of the action control code.

22. The apparatus of claim 21, further comprising a transmitter integrated with the remote control, wherein activation of the action control code triggers transmission of a corresponding signal from the transmitter.

23. The apparatus of claim 18 wherein the intermediary unit is further capable to modify a request sent from the browser to the network.

24. A system, comprising:
a set top box for an interactive television system;
a remote control for the set top box, the remote control including a browser;
an intermediary unit coupled between a network and the remote control to receive information sent between the browser and the network; and
a display device integrated with the remote control to display television program schedule information obtainable by the intermediary unit from the network, the intermediary unit capable to modify the obtained television program schedule information to add controls corresponding thereto prior to display of the modified television program schedule information on the display device by the browser, wherein activation of one of the controls added to the television program schedule information is capable to result in transmission of a corresponding signal from the remote control to the set top box.

25. The system of claim 24, further comprising a transceiver unit communicatively coupleable between the remote control unit and the set top box, wherein the signal is capable of being transmitted from the remote control to the set top box via the transceiver unit.

26. The system of claim 24 wherein activation of another one of the controls is capable to result in transmission of another signal from the remote control to a device different from the set top box.

27. The system of claim 24 wherein modification of the obtained television program schedule information include use of a transcoding technique by the intermediary unit.

28. A method, comprising:
obtaining television program schedule information from a network;
modifying the obtained information to add controls corresponding to the obtained information;
displaying the modified information having the controls; and
responsive to user activation of one of the controls added to the displayed modified information, transmitting a corresponding signal to control a device.

29. The method of claim 28 wherein adding controls to the obtained information includes adding action control code to a file associated with the obtained information, wherein user activation of one of the controls includes activation of the added action control code.

30. The method of claim 28, further comprising modifying the obtained information to change a format of the obtained information, add an element to the obtained information, delete an element from the obtained information, or change an organization or layout of the obtained information.

31. The method of claim 28, further comprising modifying a request sent from the browser to obtain the television program schedule information from the network.

32. The method of claim 28 wherein displaying the modified information having the added controls includes displaying a controllable electronic program guide.

33. The method of claim 28 wherein transmitting the corresponding signal to control the device includes transmitting the corresponding signal via a transceiver unit.

34. An article of manufacture, comprising:
a machine-readable medium having instructions stored thereon to:
obtain television program schedule information from a network;
modify the obtained information to add controls corresponding to the obtained information;
display the modified information having the controls; and
responsive to user activation of one of the controls added to the displayed modified information, transmitting a corresponding signal to control a device.

35. The article of manufacture of claim 34 wherein the instructions to modify the obtained information to add controls corresponding to the obtained information includes instructions to add action control code to a file associated with the obtained information, the action control code capable of activation in response to a user's invoking of an action control.

36. The article of manufacture of claim 34 wherein the machine-readable medium further includes instructions stored thereon to modify a request to obtain the television program schedule information from the network.

37. The article of manufacture of claim 34 wherein the machine-readable medium further includes instructions stored thereon to modify a request to display the modified information having the controls as part of an electronic program guide.
